(19) United States
(12) Patent Application Publication
(10) Pub. No.: US 2015/0207660 A1
(43) Pub. Date: Jul. 23, 2015

(54) CLIENT-SIDE URL REDIRECTION

(71) Applicant: Google Inc., (US)

(72) Inventors: Sridhar Sundaram, Bangalore (IN); Ramkumar Ramani, San Jose, CA (US); Megha Mohabey, Bangalore (IN)

(73) Assignee: Google Inc., Mountain View, CA (US)

(21) Appl. No.: 13/707,177

(22) Filed: Dec. 6, 2012

Related U.S. Application Data
(60) Provisional application No. 61/569,654, filed on Dec. 12, 2011.

(51) Int. Cl. H04L 29/06

(52) U.S. Cl. CPC H04L 29/06047

(57) ABSTRACT

A method may include, by a processor, receiving a request from a client system for a first web page, transmitting to the client system the first web page comprising one or more navigation controls that invoke one or more uniform resource locators (URLs) that are subject to redirection, sending to the client system a redirection table that comprises at least one URL pattern and a corresponding redirected URL model, receiving a second request from the client system for a second web page referenced by a rewritten URL based on the redirected URL model in place of a selected URL included on the first web page; and sending data corresponding to the rewritten URL to the client system.

### CROSS-REFERENCE TO RELATED APPLICATIONS

This application claims priority to U.S. Provisional Application No. 61/569,654, filed on Dec. 12, 2011, the disclosure of which is incorporated herein by reference in its entirety.

### BACKGROUND

The embodiments described herein generally relate to client-side redirection of uniform resource locators (URLs). URL redirection is used in a variety of circumstances. For instance, when a user types a misspelled URL, such as “exmaple.com”, their request may be redirected by a responding server to the correctly spelled “example.com”. When a web site permanently moves to a new URL, it may leave behind a redirection that causes visitors to the old URL to be automatically redirected by a server to the new URL. URL shortening is another use of server side URL redirection.

JavaScript and Frame redirections are sometimes used to obscure the final destination of a link, sometimes from crawlers and other times from potentially malicious targets.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a method may include, by a processor, receiving a request from a client system for a first web page, transmitting to the client system the first web page comprising one or more navigation controls that invoke one or more uniform resource locators (URLs) that are subject to redirection, sending to the client system a redirection table that comprises at least one URL pattern and a corresponding redirected URL model, receiving a second request from the client system for a second web page referenced by a rewritten URL based on the redirected URL model in place of a selected URL included on the first web page; and sending data corresponding to the rewritten URL to the client system.

In an embodiment, a method may include receiving, by a client system, a first web page comprising one or more navigation controls that invoke one or more uniform resource locators (URLs) that are subject to redirection, accessing, by the client system, a redirection table that comprises at least one URL pattern and a corresponding redirected URL model, receiving, by the client system, a selected URL corresponding to a user navigation command, locating the selected URL in the redirection table, generating a rewritten URL based on the redirected URL model corresponding to the selected URL, and sending a request for access to the rewritten URL in place of the selected URL.

In an embodiment, a system may include a computing device and a computer-readable storage medium in communication with the computing device. The computer-readable storage medium may include one or more programming instructions that, when executed, cause the computing device to receive a request from a client system for a first web page, send the client system the first web page comprising one or more navigation controls that invoke one or more uniform resource locators (URLs) that are subject to redirection, send to the client system a redirection table that comprises at least one URL pattern and a corresponding redirected URL model, receive a second request from the client system for a second web page referenced by a rewritten URL based on the redirected URL model in place of a selected URL included on the first web page, and send data corresponding to the rewritten URL to the client system.

In an embodiment, a system may include a computing device and a computer-readable storage medium in communication with the computing device. The computer-readable storage medium may include one or more programming instructions that, when executed, cause the computing device to receive a first web page comprising one or more navigation controls that invoke one or more uniform resource locators (URLs) that are subject to redirection, access a redirection table that comprises at least one URL pattern and a corresponding redirected URL model, receive a selected URL corresponding to a user navigation command, locate the selected URL in the redirection table, generate a rewritten URL based on the redirected URL model corresponding to the selected URL, and send a request for access to the rewritten URL in place of the selected URL.

### BRIEF DESCRIPTION OF THE DRAWINGS

FIG. 1 is an example of a caching model in which client-side URL redirection may be performed according to an embodiment.

FIG. 2 is an example of a client system according to an embodiment.

FIG. 3 provides an example of a message flow with client-side URL redirection according to an embodiment.

FIGS. 4-6 illustrate example flow charts of processing client-side redirection according to various embodiments.

FIG. 7 illustrates an example of a rendered web page with elements having different degrees of variability according to an embodiment.

FIG. 8 depicts a block diagram of example hardware that may be used to contain or implement program instructions according to an embodiment.

### DETAILED DESCRIPTION

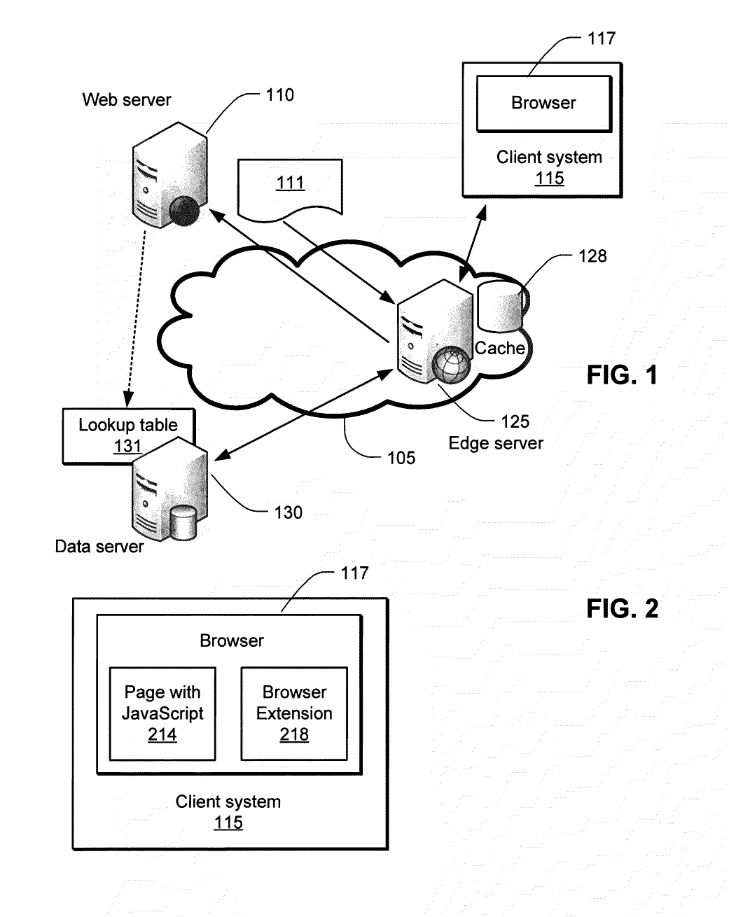

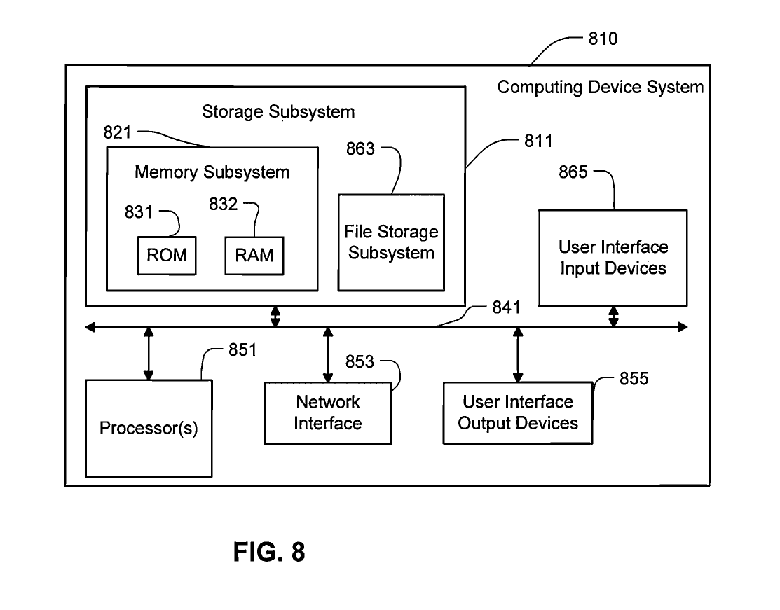

FIG. 1 illustrates an example of a caching model that includes a client system 115, a web server 110, a data server 130 and an edge server 125. A client system may include one or more local computing devices. In an embodiment, a computing device may refer to a computer or other machine that performs one or more operations according to one or more programming instructions. Example elements of a computing device are discussed below in the context of FIG. 8.

In an embodiment, a web server may refer to a computing device and/or a software application that is used to deliver web pages or other web content via a network, such as the Internet. In an embodiment, an edge server may refer to a computing device that is positioned to serve as a gateway for communication between two or more networks. For example, an edge server may refer to a computing device that serves as a gateway for communication between a private network and the Internet.

A client system 115 may use a browser 117 to request and render one or more web pages. A request may be made via a network 105 to a web server 110, which may return information 111. The information may include one or more web pages or portions or components of one or more web pages. In an embodiment, a network may be a local area network (LAN), a wide area network (WAN), a mobile or cellular communication network, an extranet, an intranet, the Internet and/or the like.

In an embodiment, a request may pass through an edge server 125. A user may interact with a web server 110 through the client system 115. The client system 115, the web server 110, edge server 125 and data server 130 each include memory for storing data and/or software applications, a processor for accessing data and executing applications, and/or components that facilitate communicate over the communication network 105. The client system 115 may execute one or more applications, such as a web browser 117, that allows a user to request content from the web server 110 and/or display information returned by the web server 110 and/or data server 130. The web server 110 may receive one or more requests from the client system 115, and may return information 111. In an embodiment, the web server 110 may interact with a data server 130 when responding to a request. In another embodiment, the web server 110 may return information that references the data server 130. The client system 115 may use such information to request content from the data server 130 directly. The edge sever 125 may be a component of a content delivery network (CDN). A CDN may be a distributed network of a plurality of computing devices, such as, for example, servers. As such, even though FIG. 1 illustrates only one edge server 125, additional edge servers may be used within the scope of this disclosure. A CDN may include multiple edge servers 125 that are positioned in locations that reduce the latency of content delivery to client systems 115. In an embodiment, an edge server 125 may include a cache 128. The use of a cache 128 may reduce the response time experienced by the client system 115.

A web page may include at least one variable element with a data request. A variable element may refer to a portion of a web page that is configured to change. For example, a web page for a retailer may include variable elements corresponding to pictures of merchandise for sale. In an embodiment, a data request having at least one variable element may be directed to a data server 130. The edge server 125 may receive the request, but may redirect the request to the data server 130 if it is not accompanied by an HTTP header specifying page cacheability. In an embodiment, the data server 130 may return the requested data. On some web pages, a technology known as Asynchronous JavaScript and XML (AJAX) may be implemented, which leaves open a channel from the client system to the data server for repeated data requests.

As discussed above, an edge server 125 may include or be in electronic communication with a data cache 128. This location of the data cache 128 may be beneficial since an operator of the CDN may be better able to modify the edge server architecture than users and browser providers are in modifying competing browser architectures. Alternatively, a cache may be maintained by a local proxy server.

As illustrated by FIG. 1, the data server 130 may include or be in electronic communication with a lookup table 131. In an embodiment, a data server 130 may use a lookup table 131 to access one or more retrieval hints. For example, a data server 130 may access one or more retrieval hints upon receipt of a data request. In an embodiment, a retrieval hint may include one or more request and hint pairs.

In an alternate embodiment, an edge server 125 may include or be in electronic communication with a lookup table 131. The edge server 125 may append one or more retrieval hints to a data request sent to the data server 130.

In an embodiment, a lookup table 131 associated with a data server 130 may be populated with one or more retrieval hints. The one or more retrieval hints may be received from the web server 110. Alternatively, if the lookup table 131 is associated with the edge server 125, it may be populated dynamically. For example, an entry to a lookup table 131 may be added when a web page 111 associated with a retrieval hint passes through the edge server on the way to the client system 115. As another example, a lookup table 131 associated with an edge server 125 may be populated directly by the web server 110.

Partial page caching may be more effective if the shared part of a web page remains active in the browser, instead of being automatically reset by issuance of a URL update request. Of course, client-side URL redirection may have broader application. For instance, client-side URL redirection can be used to switch a user between a parallel implementations of a website.

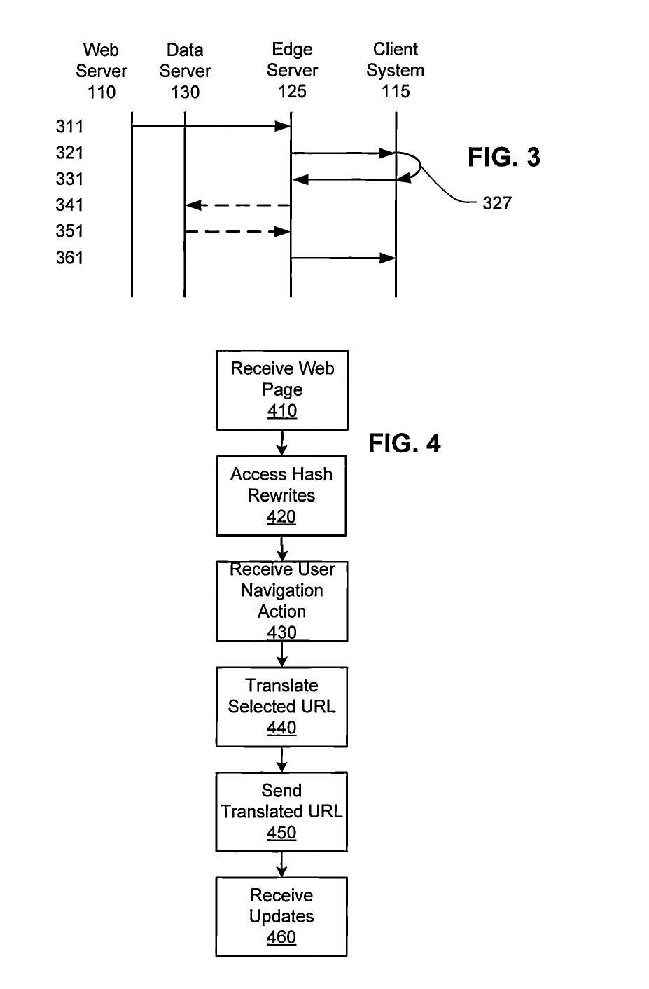

FIG. 2 illustrates examples of alternative implementations of client-side URL redirection at a browser according to an embodiment. One implementation may use JavaScript™ 214 delivered to a browser 117 with a web page. The JavaScript code 214 may include a redirection table. A redirection table may include one or more URL patterns and one or more corresponding redirected URL models according to an embodiment. A URL pattern may be a set of ordered characters that may be used to match one or more URLs. In an embodiment, a URL model may be a representation of one or more URLs. For example, a URL model may include one or more placeholder symbols, characters and/or the like that represent at least a portion of a URL. In an embodiment, a URL model may include one or more complete URLs.

For example, a redirection table may include a URL or a portion of a URL associated with an originally requested web page and a corresponding URL associated with a web page to which requests for the originally requested web page should be redirected. Table 1 and Table 2 illustrate example redirection tables according to various embodiments. As illustrated by Table 1, a request for a web page associated with the URL “www.example.com/boots1.html” may be redirected to a web page associated with the URL “www.example.com/boots#1”.

TABLE 1

| Original in web page | Redirect request by browser to |
|---|---|
| www.example.com/boots1.html | www.example.com/boots#1 |
| www.example.com/boots2.html | www.example.com/boots#2 |

TABLE 2

| URL Pattern | Hash Rewrite |
|---|---|
| www.example.com/base/*.html | www.example.com/base#* |
| www.example.com/base/pre*.html | www.example.com/base#pre* |
| www.example.com/base2/ | www.example.com/base2# |

In an embodiment, an implementation of client-side URL redirection at a browser may use a browser extension 218. With a browser extension 218, one or more redirection tables may accompany web pages, as JavaScript Object Notation (JSON) objects or in another data format. Alternatively, one or more redirection tables may be provided to the browser extension via a different channel, such as through software updates. Other implementations not shown in FIG. 2 include use of a Java applet or integration of redirection code into the browser.

A fashion shopping web site may be considered as an example. The general layout of a merchandise selection page may include numerous fashion photos. Regardless of the fashion category, some elements of a merchandise selection web page, such as, for example, a company banner, top level menu bars and search controls, may remain static. JavaScript code and style sheets also may be common across merchandise selection pages. However, one or more pictures of merchandise may change with page turns. Some elements may be shared among a handful of pages, such as across selection pages for boots.

Without the technology described in this specification, each time a URL changes, such as from www.example.com/boots1.html to www.example.com/boots2.html, a browser refreshes the entire page, including the static elements such as top level menu bars and the shared elements. Much of this refresh may be avoided by handling refresh on an element basis instead of a page basis using client side URL redirection.

In an example embodiment, deployment of AJAX may introduce a browser behavior that may be exploited by client-side URL redirection in lieu of or in addition to AJAX coding of web pages. Browsers may now avoid refreshing a whole page when the only part of a URL that changes is a hash fragment. A hash fragment may refer to at least a portion of a URL. In the example above, a refresh of a whole page may be avoided by coding the second URL invoked as www.example.com/boots#2. Upon navigation from . . . /boots#1 to . . . /boots#2, use of the client side rewriting of the URL may avoid a whole page refresh without requiring extensive rewriting of the code associated with the web page. In this example, the hash fragment is the text following the hash or pound sign. The hash sign may be a delimiter and not part of the hash fragment. A browser that encounters this sequence of URLs may determine that the text “ . . . /boots” did not change, but that only the hash fragment changed from “1” to “2.” Because only the hash tag changed, the browser may avoid a whole page refresh and may invoke the URL expecting partial replacement web page content. In an embodiment, client-side URL redirection may translate existing web page references into modified URL references that use hash tags, as illustrated above, thereby reducing the extent of refreshes. More generally, any client-side redirection from one URL to another may be supported.

In an embodiment, one or more groups of web pages that satisfy a URL pattern may be migrated to a new format. A redirection table may be updated when the new format is available. As such, it may not be necessary to rewrite all of the URLs in pages connected to newly formatted pages. A redirection module (not shown) may handle the rewriting of URLs, on either an interim basis or permanent basis.

In an embodiment, client-side implementation of URL redirection may also support switching between parallel implementations. The redirection can be conditional, and the condition may be triggered in many alternative ways.

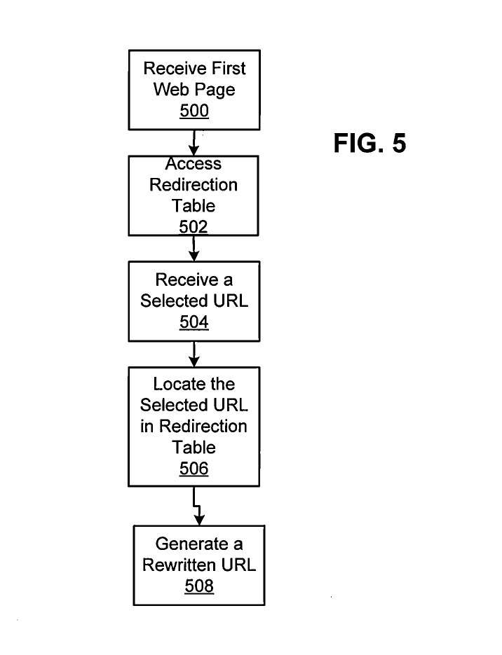

FIG. 3 illustrates an example of a message flow among the web server 110, data server 130, edge server 125 and client system 115 during a client-side URL redirection that rewrites URLs to rely on hash tags according to an embodiment. As illustrated by FIG. 3, the edge server 125 may receive 311 web page content from a web server 110. In an embodiment, the edge server 125 also may receive content from a data server 130, although this embodiment is not depicted in FIG. 3. The edge server 125 may have access to retrieval hints, such as for cacheability and criticality. Responsive to a request from a client system 115, the edge server 125 may send 321 a web page to the client system 115. The web page may include one or more navigation controls that would invoke one or more URLs that may cause the browser to refresh the entire web page if the URLs are not redirected. The client system 115 may perform URL redirection 327 and may send a request 331 to the edge server 125 that includes a hash tag, a specification that selects among a group of web pages having similar layouts. As necessary, the edge server 125 may request 341 and receive data 351 from a data server 130. For instance, when the request involves a page in a new group of web pages with different layouts, the edge server 125 may retrieve data requested from a web server 130 (not illustrated by FIG. 3). Occasionally, this may occur when the edge server 125 refreshes even static layout data after a predetermined refresh interval. Most of the time, the edge server 125 may respond 361 to requests for static layout (or nearly static layout) from its own cache 128, without communicating with the web server 110 or waiting for a response.

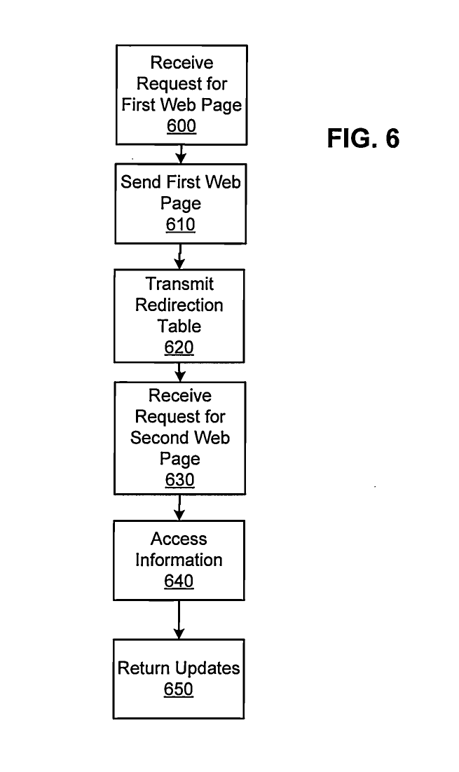

FIG. 4 illustrates an example flow chart of a client system's URL redirection according to an embodiment. In an embodiment, a client system may receive 410 a web page that includes URLs to be rewritten. In one implementation, the URLs are rewritten to substitute hash tags for the last level of URL specification. In other implementations, specific substitutions may be provided, which optionally may use hash coding to avoid triggering a refresh.

A module running on the client system may access 420 a hash code rewrites table. In an embodiment, a module may be a software component, a hardware component or a combination software/hardware component. In general and not limited to use of hash tags, the module may access URL substitution data, which may be a table, a substitution pattern, a rule set or other translation specification data. Tables 1 and 2 presented above provide examples of alternative implementations of a hash rewrites table according to an embodiment. Table illustrates an example of mapping URLs to redirected URLs. Table 2 includes examples of substitution patterns, where a pattern and a rewrite both include wild cards. Using a pattern, any URL that matches the pattern and its wild cards may be mapped to a specified rewrite. Another example implementation may apply one or more transformation rules to particular URLs.

Before or after accessing the hash rewrites, the client system may receive a user navigation action 430. The navigation action may indicate that a user accessed at least a portion of a web page. For example, a navigation action may indicate that a user selected a link, that a user spoke a selection command, that a user made a selection from a menu and/or the like. Alternatively, the client navigation may involve a hot key or a macro. The client system may interpret the navigation action and may identify a URL corresponding to the user navigation action.

Upon receiving a user navigation that invokes a URL request, a module running on the client system may translate the selected URL 440. Some URLs may not match a URL pattern or will otherwise be candidates to be rewritten. If no translation specification matches a URL, no translation may be applied. The URLs for which there is a translation or rewrite available may be translated 440. The client system may send the translated URL 450 via the network for delivery following the client-side URL redirection.

In an embodiment, in response to one or more URLs being sent by the client system, one or more updates may be received 460 by the client system that apply to one or more portions of a web page previously received 410 by the client system. An update may be a layout update and/or a data update. In an embodiment, an update may be an alternative version of a web page. An update may be used to update a web page rendered by a browser, which a client system may display to a user.

FIG. 5 illustrates a flow chart for an example method of generating a rewritten URL according to an embodiment. As illustrated by FIG. 5, a client system may receive 500 a first web page. The first web page may include one or more URLs that may be subject to redirection. In an embodiment, the client system may access 502 a redirection table. The redirection table may include at least one URL pattern and a corresponding redirected URL model. In an embodiment, the redirection table may be available to the client system prior to receiving the first web page, it may accompany the first web page, or it may be accessed by the client system after it receives the first web page. In an embodiment, the client system may receive one or more programming instructions that include a redirection table and one or more programming instructions for locating the selected URL and for generating the rewritten URL. One or more of the programming instructions may be JavaScript.

In an alternate embodiment, the client system may receive one or more programming instructions for locating the selected URL and generating the rewritten URL, and separately receiving a redirection table. In an embodiment, the one or more programming instructions may include a Java applet or a browser extension. The first web page may be received by a browser.

The client system may receive 504 a selected URL corresponding to a user navigation action. The client system may locate 506 the selected URL in the redirection table, and may generate 508 a rewritten URL using the redirected URL model corresponding to the selected URL in the redirection table. In an embodiment, the rewritten URL may be different than the URL corresponding to the first web page. In an embodiment, a client system may apply a URL pattern to a group of related pages that share one or more common layout features. The redirected URL model may distinguish among the related pages by using one or more hash fragments. In such cases, the client system may receive a partial, but not complete, refresh of content of the first web page.

FIG. 6 illustrates a flow chart for an example method of performing client-side URL redirection from the perspective of a device that responds to the client system, such as an edge server, according to an embodiment. While reference is made to an edge server, another device such as, for example, a web server or local proxy might perform the actions identified in FIG. 6. As illustrated by FIG. 6, an edge server may receive 600 a request from a client system for a first web page. The edge server may send 610 the first web page to the client system. In an embodiment, the first web page may include one or more URLs that are subject to redirection. Either the edge server or another device (not shown) may transmit 620 a redirection table to the client system. The redirection table may include one or more URL patterns and corresponding redirected URL models. In an embodiment, the redirection table may include one or more hash rewrites or other URL redirections. Other URL redirections may be substituted for hash rewrites, as described above. In an embodiment, an edge server may transmit 620 a redirection table before, with or after sending the first web page.

In an embodiment, one or more entries in a redirection table may include a URL pattern that applies to a group of related web pages that share one or more common layout features. The redirected URL model may distinguish among the related pages by using one or more hash fragments. In this embodiment, the edge server may send a partial but not complete refresh of content of the first web page to the client system in response to receiving a rewritten URL.

The edge server may receive 630 a request for a second web page that is referenced by a rewritten URL based on the redirected URL model in place of a selected URL included on the first web page. For instance, a first web page transmitted to a client system may include the URL www.example.com/base/boot2.html as illustrated by Table 1. A user who navigates toward this URL may be redirected to www.example.com/base#boot2, as illustrated by Table 1. The URL may be rewritten on the client side after delivery of the first web page so that the URL associated with the second web page that is received 630 by the edge server may be different than the URL associated with the first web page.

In an embodiment, the edge server may access 640 information associated with the second web page. At least a portion of such information may be stored in the edge server's cache. In an embodiment, some or all of the information may be obtained from a web server or a data server. In an embodiment, after accessing the requested information, the edge server may return 650 an update to the client system.

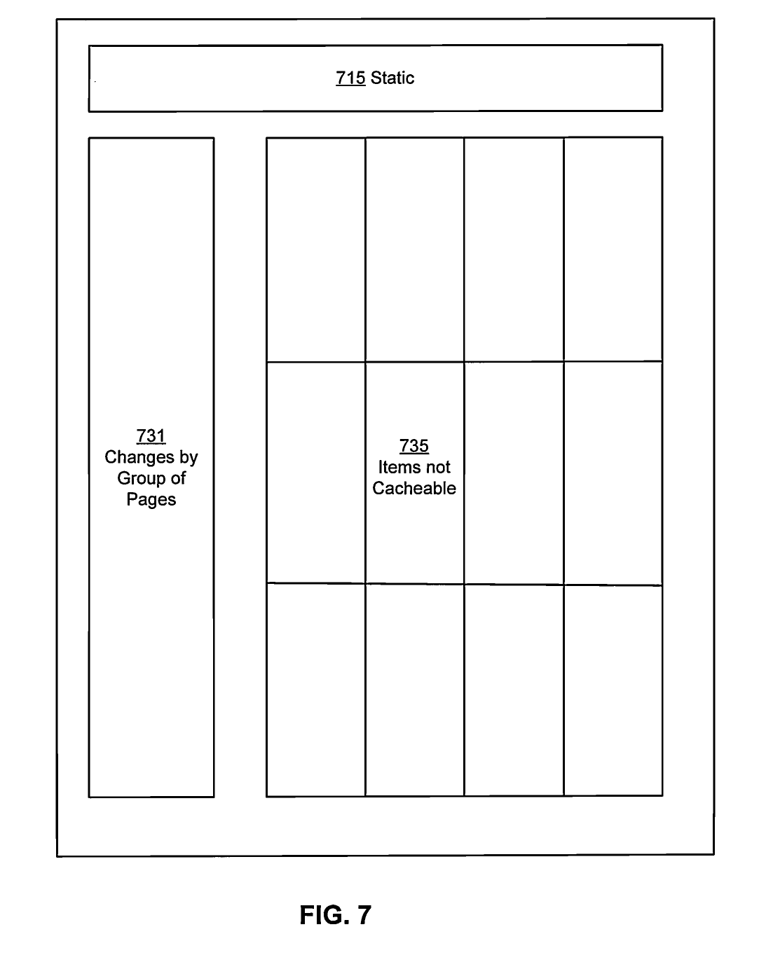

FIG. 7 illustrates an example web page according to an embodiment. As illustrated by FIG. 7, a web page may include one or more different static sections 715 and/or one or more varying element sections 731, 735. A static section may be a static header, a site-wide navigation control, a search control and/or the like. In an embodiment, a static section may remain static for a period of time longer than a cache refresh interval. For example, a static section may change once a month, once a week, or, for a frequently accessed site, daily. For example, an edge server may refresh one or more static sections every hour for a site that has millions of hits per day with no significant loss of cache efficiency.

In an embodiment, a web page may include a varying element section 731 that changes by group of pages. For instance, referring to the fashion web page example discussed above, the fashion web page may include one or more filter controls that may change by clothing group. For example, the filters that apply to boots may be the same for different groupings of boots. The browser need not refresh the filter controls as a user navigates among different styles of boots. However, when the user moves on to hats, the manufacturers, styles, price ranges and/or other parameters may change. At this point, the filter controls may need to refresh.

In an embodiment, a web page may include a varying element section 735 that includes items that are not cacheable. For example, fashion photos and accompanying descriptions on a fashion web site may frequently change, making them relatively difficult to cache. As such, one or more items that are not cacheable may be retrieved from a data server. This may take advantage of a criticality hint that limits the number of items that need to be returned in a first batch for display to a user.

The technology disclosed may be practiced as a method or device adapted to practice the method. It can be described from either the perspective of a client system and/or from the perspective of one or more servers communicating with a client system. The technology may be an article of manufacture such as, for example, non-transitory storage loaded with one or more programming instructions to carry out computer-assisted processing of web pages that, when loaded onto appropriate hardware, enables the hardware to carry out any of the methods disclosed. Similarly, the technology may be an article of manufacture such as, for example, non-transitory storage loaded with program instructions that, when used in connection with appropriate hardware, serves as a development server.

FIG. 8 illustrates a block diagram of an example computing device system on which the various systems described herein may be implemented. Computing device system 810 may include at least one processor 851, which may communicate with one or more peripheral devices via bus subsystem 841. These peripheral devices may include a storage subsystem 811 that includes, for example, one or more memory devices 831, 832, a file storage subsystem 863, one or more user interface input devices 865, one or more user interface output devices 855, and/or a network interface subsystem 853. The input and output devices may allow user interaction with computer system 810. Network interface subsystem 853 may provide an interface to a communication network and may be coupled via the communication network to corresponding interface devices in other computer systems. The communication network may include one or more interconnected computer systems and communication links. These communication links may be wireline links, optical links, wireless links, or any other mechanisms for communication of information. In an embodiment, the communication network attached to the interface may be the Internet. In other embodiments, the communication network may be any suitable computer network.

User interface input devices 865 may include a keyboard, pointing devices, such as, for example, a mouse, trackball, touchpad, or graphics tablet, a scanner, a touchscreen, audio input devices such as, for example, voice recognition systems or microphones, and/or other types of input devices. In general, use of the term “input device” is intended to include possible types of devices and ways to input information into computing device system 810 or onto the communication network.

User interface output devices 855 may include a display subsystem, a printer, a fax machine, and/or non-visual displays such as audio output devices. The display subsystem may include a cathode ray tube (CRT), a flat-panel device such as a liquid crystal display (LCD), a projection device, or some other mechanism for creating a visible image. The display subsystem may also provide a non-visual display such as via audio output devices. In general, use of the term “output device” is intended to include all possible types of devices and ways to output information from computing device system 810 to the user or to another machine or computer system.

Storage subsystem 811 may store programming and data constructs that provide the functionality of some or all of the modules described throughout this disclosure. These modules may be executed by processor 851 alone or in combination with other processors.

Memory 821 used in the storage subsystem may include one or more memories including a main random access memory (RAM) 832 for storage of instructions and data during program execution, and a read-only memory (ROM) 831 in which fixed instructions may be stored. A file storage subsystem may provide persistent storage for program and data files, and may include a hard disk drive, a floppy disk drive along with associated removable media, a CD-ROM drive, an optical drive, and/or removable media cartridges. The modules implementing the functionality of certain embodiments may be stored by file storage subsystem 863 of the storage subsystem 811, or in other machines accessible by the processor.

Bus subsystem 841 may provide a mechanism for letting the various components and subsystems of computing device system 810 communicate with each other as intended. Although bus subsystem 841 is shown schematically as a single bus, alternative embodiments of the bus subsystem may use multiple busses.

Computing device system 810 may be of varying types including a smart phone, tablet, laptop, workstation, server, computing cluster, blade server, server farm, or any other data processing system or computing device. The description of computing device system 810 depicted in FIG. 8 is intended only as an example using a so-called particular computer adapted by programming instructions to perform as disclosed. Many other configurations of computing device system 810 are possible having additional or fewer components than the computer system depicted in FIG. 8.

The technology in the methods described above can be practiced as an apparatus. In practice, the client-side URL redirection clients may be implemented on a client system or apparatus that includes one or more processors and memories (collectively “hardware”), running computer instructions that cause the development server to carry out any of the client system methods described. Similarly, server support of client-side URL redirection clients may be implemented on a server system or apparatus that includes one or more processors and memories (collectively “hardware”), running computer instructions that cause the development server to carry out any of the server system methods described.

The technology in the methods described above can be practiced as an article of manufacture that includes computer instructions in non-transitory storage. The computer instructions may implement or support computer-assisted client-side URL redirection when loaded onto appropriate client hardware or server hardware, respectively. The instructions enable the hardware to carry out any of the described methods. Similarly, technology may be non-transitory storage loaded with program instructions that, when loaded onto appropriate hardware, produces any of the client systems or server devices described.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method comprising, by a processor:
receiving a request from a client system for a first web page;
transmitting to the client system the first web page comprising one or more navigation controls that invoke one or more uniform resource locators (URLs) that are subject to redirection;
sending to the client system a redirection table that comprises at least one URL pattern and a corresponding redirected URL model;
receiving a second request from the client system for a second web page referenced by a rewritten URL based on the redirected URL model in place of a selected URL included on the first web page; and
sending data corresponding to the rewritten URL to the client system.

2. The method of claim 1, wherein at least one entry in the redirection table comprises:
a URL pattern that applies to a group of related pages that share one or more common layout features; and
a corresponding redirected URL model that comprises a hash fragment to distinguish among the related pages.

3. The method of claim 1, further comprising sending to the client system in response to the rewritten URL a partial but not complete refresh of content of the first web page.

4. The method of claim 1, wherein at least one entry in the redirection table comprises:
a URL pattern identifying a first URL; and
a corresponding redirected URL model identifying a second URL.

5. The method of claim 1, wherein sending to the client system a redirection table comprises:
sending computer code to the client system, wherein the computer code includes the redirection table; and
sending one or more computer instructions for locating the selected URL and generating the rewritten URL to the client system.

6. The method of claim 5, wherein the computer code comprises JavaScript.

7. The method of claim 1, further comprising:
sending to the client system one or more computer instructions for locating the selected URL and generating the rewritten URL, wherein sending the one or more computer instructions comprises sending the one or more computer instructions separately from the redirection table.

8. The method of claim 7, wherein the computer instructions comprise a Java applet.

9. A method comprising:
receiving, by a client system, a first web page comprising one or more navigation controls that invoke one or more uniform resource locators (URLs) that are subject to redirection;
accessing, by the client system, a redirection table that comprises at least one URL pattern and a corresponding redirected URL model;
receiving, by the client system, a selected URL corresponding to a user navigation command;
locating the selected URL in the redirection table;
generating a rewritten URL based on the redirected URL model corresponding to the selected URL; and
sending a request for access to the rewritten URL in place of the selected URL.

10. The method of claim 9, wherein at least one entry in the redirection table comprises:
a URL pattern that applies to a group of related pages that share one or more common layout features; and
a corresponding redirected URL model that comprises a hash fragment to distinguish among the related pages.

11. The method of claim 9, further comprising receiving, in response to sending a request for access to the rewritten URL, a partial but not complete refresh of content of a first web page.

12. The method of claim 9, wherein at least one entry in the redirection table comprises:
a URL pattern identifying a first URL; and
a corresponding redirected URL model identifying a second URL.

13. The method of claim 9, wherein accessing a redirection table comprises receiving computer code comprising:
the redirection table; and
one or more computer instructions for locating the selected URL and generating the rewritten URL.

14. The method of claim 13, wherein:
the computer code comprises one or more of JavaScript and a browser extension; and
the computer instructions comprise a Java applet.

15. A system comprising:
a computing device; and
a computer-readable storage medium in communication with the computing device, wherein the computer-readable storage medium comprises one or more programming instructions that, when executed, cause the computing device to:
receive a request from a client system for a first web page,
send the client system the first web page comprising one or more navigation controls that invoke one or more uniform resource locators (URLs) that are subject to redirection,
send to the client system a redirection table that comprises at least one URL pattern and a corresponding redirected URL model,
receive a second request from the client system for a second web page referenced by a rewritten URL based on the redirected URL model in place of a selected URL included on the first web page, and
send data corresponding to the rewritten URL to the client system.

16. The system of claim 15, wherein the one or more programming instructions that, when executed, cause the computing device to send the client system a redirection table comprises one or more programming instructions that, when executed, cause the computing device to send the client system a redirection table that comprises at least one entry that comprises:
a URL pattern that applies to a group of related pages that share one or more common layout features; and
a corresponding redirected URL model that comprises a hash fragment to distinguish among the related pages.

17. The system of claim 15, wherein the computer-readable storage medium further comprises one or more programming instructions that, when executed, cause the computing device to send to the client system in response to the rewritten URL a partial but not complete refresh of content of the first web page

18. A system comprising:
a computing device; and
a computer-readable storage medium in communication with the computing device, wherein the computer-readable storage medium comprises one or more programming instructions that, when executed, cause the computing device to:
receive a first web page comprising one or more navigation controls that invoke one or more uniform resource locators (URLs) that are subject to redirection,
access a redirection table that comprises at least one URL pattern and a corresponding redirected URL model,
receive a selected URL corresponding to a user navigation command,
locate the selected URL in the redirection table,
generate a rewritten URL based on the redirected URL model corresponding to the selected URL, and
send a request for access to the rewritten URL in place of the selected URL.

19. The system of claim 18, wherein the one or more programming instructions that, when executed, cause the computing device to access a redirection table comprise one or more programming instructions that, when executed, cause the computing device to access a redirection table that comprises at least one entry that comprises:
a URL pattern that applies to a group of related pages that share one or more common layout features; and
a corresponding redirected URL model that comprises a hash fragment to distinguish among the related pages.

20. The system of claim 18, wherein the computer-readable storage medium further comprises one or more programming instructions that, when executed, cause the computing device to receive, in response to sending a request for access to the rewritten URL, a partial but not complete refresh of content of a first web page.
